(19) United States
(12) Patent Application Publication
(10) Pub. No.: US 2003/0069800 A1
(43) Pub. Date: Apr. 10, 2003

(54) Mobile wireless image capture and printing method and system

(75) Inventors: Christopher I. Marshall, Pittsford, NY (US); Ronald S. Cok, Rochester, NY (US); Robert J. Weetman, Webster, NY (US); Edward Woodrow, Fairport, NY (US); Kevin Yager, Marion, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/970,581

(22) Filed: Oct. 4, 2001

(51) Int. Cl. G06F 17/60

(52) U.S. Cl. 705/26

(57) ABSTRACT

A method and system for providing photographic services, includes a mobile image capture system that has a digital camera, an order entry device having a display for displaying images captured by the digital camera and a data input device for taking a customer order, and a wireless transceiver for transmitting the captured image and an associated customer order; providing an image fulfillment station remote from the mobile image capture system that includes a wireless transceiver for receiving transmitted images and customer order and an output device for providing an image related product; an image of a customer is captured using the digital camera; the captured image is displayed to the customer on the display at the time and location of image capture; an order from the customer is entered on the order entry device for the captured image at the time and location of image capture; the image is transmitted to a fulfillment station; and the order is fulfilled at the fulfillment station.

### FIELD OF THE INVENTION

The present invention relates to mobile capture and printing of images using wireless communications and, more particularly, to capture by multiple photographers using a common printing resource.

### BACKGROUND OF THE INVENTION

Systems for photographers taking pictures at scenic areas are known. These systems have photographers talk to customers, take pictures, and send the customers to a printing resource later in the day. Such a system is manufactured and sold as the Roving Photos Digital Imaging System by the Eastman Kodak Company. A problem with this approach is that the customers aren't interested in a picture they haven't seen, or they forget to go to the printing resource. Typical equipment used is a digital camera with removable solid state memory card, desktop PC, and thermal printer.

Moreover, photographers typically leave their station and physically carry the acquired pictures in some physical media to a printing facility. This results in lost opportunities to take more pictures. It also adds to the delay before the printing resource has access to the picture data. Alternatively, couriers are employed to carry the acquired images to the printing facility, resulting in additional costs.

U.S. Pat. No. 6,222,646 issued Apr. 24, 2001 to Maurinus et al. discloses an electronic photography system where images are captured at a number of photo-capture stations. The images are identified with the customers and a customer can view the identified images at an output station where a decision can be made to purchase the images. It has been discovered that the difference in time and location of image capture, and the time and location of viewing the captured image at the output station on the display, and deciding to purchase the image, has a significant negative impact on the decision to purchase the images.

There is a need therefore for an improved method and system for the acquisition of customer images, the presentation of the images, order taking, and printing of the images.

### SUMMARY OF THE INVENTION

The need is met according to the present invention by providing a method and system for photographic services that includes a mobile image capture system that has a digital camera, an order entry device having a display for displaying images captured by the digital camera and a data input device for taking a customer order, and a wireless transceiver for transmitting the captured image and an associated customer order; providing an image fulfillment station remote from the mobile image capture system that includes a wireless transceiver for receiving transmitted images and customer order and an output device for providing an image related product; an image of a customer is captured using the digital camera; the captured image is displayed to the customer on the display at the time and location of image capture; an order from the customer is entered on the order entry device for the captured image at the time and location of image capture; the image is transmitted to a fulfillment station; and the order is fulfilled at the fulfillment station.

### ADVANTAGES

The present invention has the advantage that it allows customers to view their images immediately upon capture and select any desired images for printing. Purchase decisions can be made immediately and image products provided to the customer at an image fulfillment station in a timely fashion, thereby significantly increasing the number of image products purchased. The photographers can remain on location without needing to leave their post to physically communicate acquired images to an image fulfillment station or employ couriers to convey the images to a fulfillment station.

### BRIEF DESCRIPTION OF THE DRAWINGS

FIG. 1 is a schematic representation of a system useful for providing photographic services according to the present invention;

FIG. 2 is a schematic representation of a system with multiple cameras and displays in a fixed architecture;

FIG. 3 is a schematic representation of a system with multiple cameras and displays in a flexible architecture; and

FIG. 4 is a schematic representation of the devices and services in an ad hoc system;

### DETAILED DESCRIPTION OF THE INVENTION

The present invention provides a method and system for acquiring an image of a customer by a photographer, immediately presenting the photograph to the customer, and upon acceptance of the photograph by the customer, transmitting the photograph and any order information to a remote printing facility.

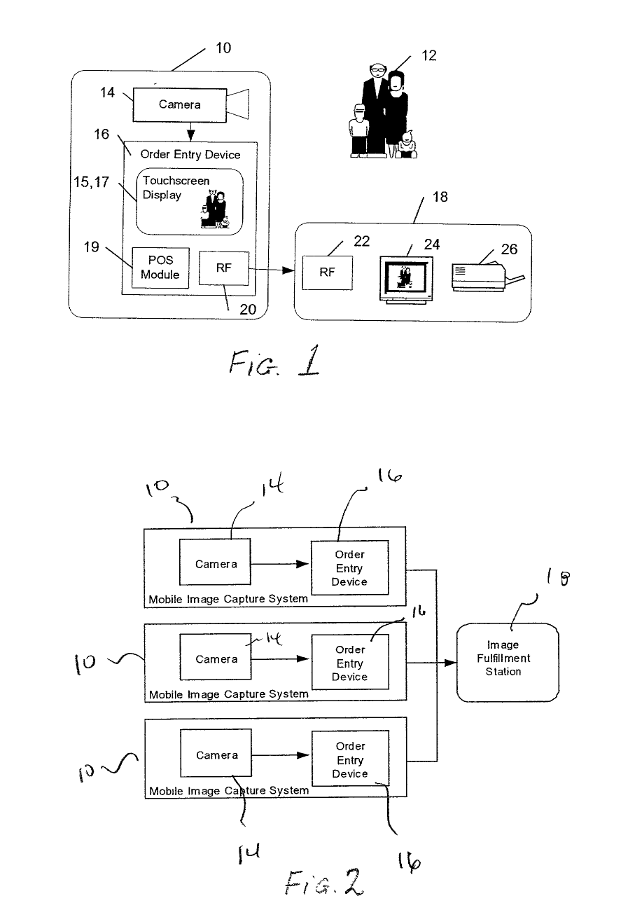

The process proceeds as illustrated in FIG. 1. Referring to FIG. 1 a mobile image capture system 10 for photographing a customer 12 includes a digital camera 14, such as a Kodak DC4800 Zoom Digital Camera and an order entry device 16, such as a Xybemaut Mobile Assistant V Wearable Computer that can be carried by the photographer. The order entry device 16 includes a display 17 a data input device 15, such as a keypad or touchscreen and a wireless transceiver 20. A captured image is transferred to and displayed on the display 17 and viewed by the customer 12. The digital camera and the order entry device may be connected by a hard wire or a wireless communications connection.

The customer views the image on the display and places a customer order for image products such as prints, merchandise or digital media bearing the image, or upload to an Internet storage site. The image and customer order data are then transmitted to an image fulfillment station 18 using a pair of RF transceivers 20 and 22 such as the Cisco Aironet 350 Series Wireless Local Area Network Client Adapter and Access Point. The customer 12 may then proceed to the image fulfillment station 18 where he or she can further review the image on a further display device 24, manipulate the image and make further purchase decisions. The image fulfillment station 18 will fulfill the order using equipment such as, for example, a printer 26, such as a Kodak Professional 8660 Thermal Printer. The order entry device 16 may include a point of sale module 19 such as the IVI CheckMate Elite 780 credit card processing device and receipt printer that prints a receipt that includes an order identification. The customer uses the receipt to identify their order at the image fulfillment station 18.

Alternatively a separate printer (not shown) may be employed to print out an order identification that can be used by the customer to identify his or her images at the image fulfillment station 18 and payment can then be made at the fulfillment station.

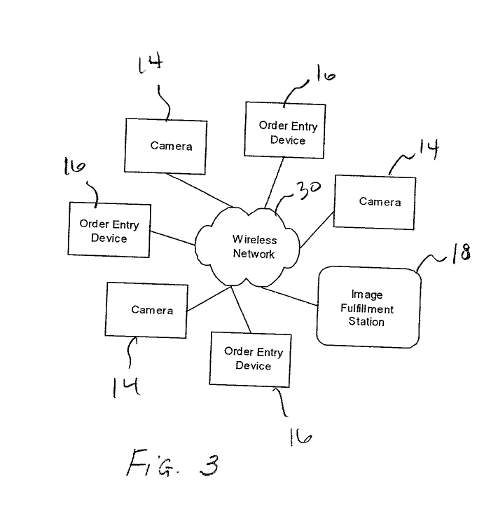

Referring to FIG. 2, in an expanded implementation, the system includes more than one image capture system 10, operated by a number of 15 photographers. The image fulfillment station 18 is capable of processing more than one transmitted image at a time.

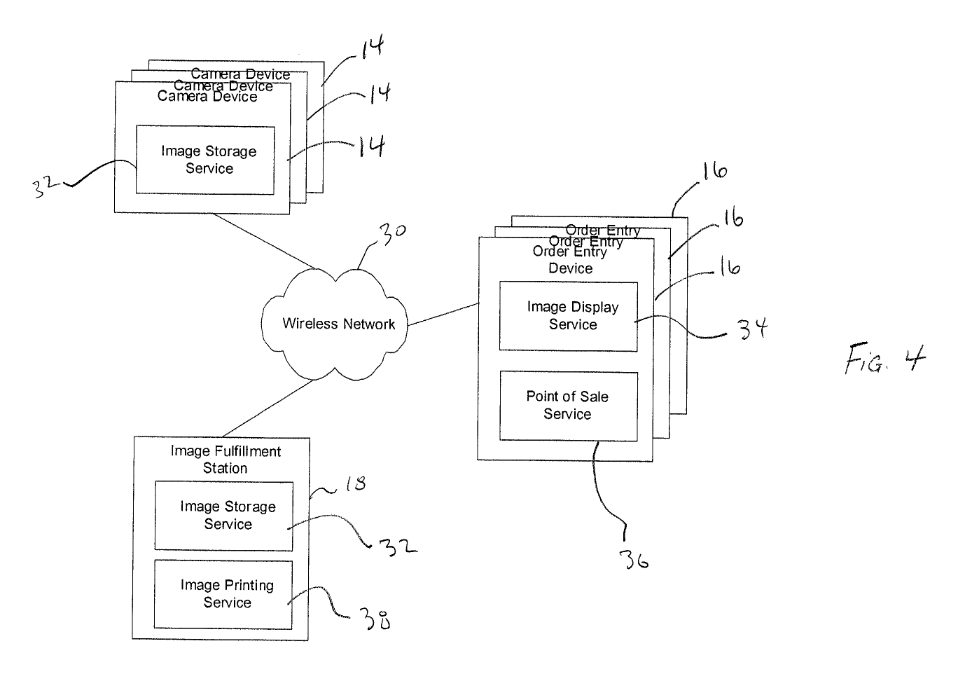

Referring to FIG. 3, in a further expansion to this implementation, the cameras 14 and order entry devices 16 are distributed among some number of photographers and operators, respectively. The order entry devices 16 are capable of transferring and displaying the images being captured by one or more of the cameras 14. The cameras, order entry devices and image fulfillment station 18 are connected via a wireless network 30. Each device is distinguishable on the network using a fixed unique identifier, such as an Internet Protocol (IP) address.

The images are transferred to the order entry devices 16 and the image fulfillment station 18 from the cameras via the wireless network 30 using a protocol such as the File Transfer Protocol (FTP) defined in the Internet Engineering Task Force (IETF) specification RFC-1123.

Referring to FIG. 4, in a further alternative embodiment, the devices on the wireless network communicate using a mobile ad hoc wireless network 30 protocol such as Universal Plug and Play (UPnP). Each device is provided with one or more services that are software modules that provide specific functions for the system. For example, the cameras 14 are each provided with an image storage service 32; the order entry devices are provided with image display and point of sale services 34 and 36; and the image fulfillment station 18 is provided with image storage 32 and image printing 38 services. In the UPnP implementation, entities on the network, be they devices or services operating in devices, spontaneously discover the other entities on the network, and present themselves to the other entities. A camera 14, for example contains an image storage service 32 that could advertise the availability of a new image. The image display service 34 in the order entry device 16 interested in displaying new images would then discover this image storage service based on that advertisement, and query the service for the image data. This type of architecture does not require fixed addressing of devices, allowing for little or no human administrative requirements. It also supports automatic adaptation to mobility and sporadic availability. The cameras and display devices are able to connect and disconnect to the network in an arbitrary manner.

A limited market test of the method and system of the present invention was conducted at a variety of locations and demonstrated a significant increase in customer purchase rates.

The invention has been described in detail with particular reference to certain preferred embodiments thereof, but it will be understood that variations and modifications can be effected within the spirit and scope of the invention.

### PARTS LIST

10 image capture system

12 customer

14 digital camera

15 data input device

16 order entry device

17 display

18 image fulfillment station

19 point of sale module

20 RF transceiver in order entry device

22 RF transceiver in image fulfillment station

24 image display device

26 printer

30 wireless network

32 image storage service

34 image display service

36 point of sale service

38 image printing service

What is claimed is:

1. A method for providing photographic services, comprising the steps of:
a) providing a mobile image capture system that includes a digital camera, an order entry device having a display for displaying images captured by the digital camera and a data input device for taking a customer order, and a wireless transceiver for transmitting the captured image and an associated customer order;
b) providing an image fulfillment station remote from the mobile image capture system that includes a wireless transceiver for receiving transmitted images and customer order and an output device for providing an image related product;
c) capturing an image of a customer using the digital camera;
d) displaying the captured image to the customer on the display at the time and location of image capture;
e) entering an order from the customer on the order entry device for the captured image at the time and location of image capture;
f) transmitting the image to a fulfillment station; and
g) fulfilling the order at the fulfillment station.

2. The method claimed in claim1 wherein the order entry device is a portable computer.

3. The method claimed in claim1 wherein the order entry device further comprises a credit card reader.

4. The method claimed in claim1 wherein the order entry device further comprises a receipt printer.

5. The method claimed in claim 1, wherein the data input device is a touch screen.

6. The method claimed in claim 1, further comprising the step of receiving payment for the customer order at the time and location of image capture.

7. The method claimed in claim 1, further comprising the step of receiving payment for the customer order at the time and location of fulfillment.

8. The method claimed in claim 1, wherein the digital camera and the order entry device are connected by a wireless communication link, and wherein the order is entered by a person other than a photographer.

9. The method claimed in claim1 wherein a plurality of photographers are provided with mobile image capture systems that communicate with the image fulfillment station.

10. The method claimed in claim 9 wherein the plurality of mobile image capture systems communicate with the image fulfillment station over a communication network employing an ad hoc communications protocol, whereby mobile image capture systems can be added or removed in real time from the network.

11. The method claimed in claim 8 wherein the mobile image capture system includes a plurality of order entry devices.

12. The method claimed in claim 8 wherein the mobile image capture system includes a plurality of digital cameras.

13. The method claimed in claim 1 further comprising the step of recording image acquisition, printing, and payment transactions at the fulfillment station.

14. A system for providing photographic services, comprising:
a) a mobile image capture system that includes a digital camera, an order entry device having a display for displaying images captured by the digital camera and a data input device for taking a customer order, and a wireless transceiver for transmitting the captured image and an associated customer order; and
b) an image fulfillment station remote from the mobile image capture system that includes a wireless transceiver for receiving transmitted images and customer order and an output device for providing an image service.

15. The system claimed in claim14 further comprising a plurality of mobile image capture systems communicating with the image fulfillment station.

16. The system claimed in claim 15 wherein the plurality of mobile image capture systems communicate with the image fulfillment station over a communication network employing an ad hoc communications protocol, whereby mobile image capture systems can be randomly added or removed from the network.

17. The system claimed in claim14 wherein the order entry device is a portable computer.

18. The system claimed in claim14 wherein the order entry device further comprises a credit card reader.

19. The system claimed in claim14 wherein the order entry device further comprises a receipt printer.

20. The system claimed in claim 14, wherein the data input device is a touch screen.

21. The system claimed in claim 14, wherein the digital camera and the order entry device are connected by a wireless communication link.

23. The system claimed in claim 14 wherein the mobile image capture system includes a plurality of order entry devices wirelessly connected to the digital camera.

24. The system claimed in claim 21 wherein the mobile image capture system includes a plurality of digital cameras wirelessly connected to the order entry station.

25. The system claimed in claim 21 wherein the mobile image capture system includes a plurality of digital cameras and order entry stations connected to a wireless communications network.

26. The system claimed in claim 14 further comprising means to accept, record, and fulfill a customer order for the acquired image at image fulfillment station.

27. The system claimed in claim 14 wherein the image fulfillment station further comprises means to accept payment for a customer order.

28. The system claimed in claim 14 wherein the image capture station further comprises means to accept payment for a customer order.

29. The system claimed in claim 14 further comprising means to record image acquisition, printing, and payment transactions.
